(19) United States
(12) Patent Application Publication
(10) Pub. No.: US 2011/0247908 A1
(43) Pub. Date: Oct. 13, 2011

(54) DYNAMIC DAMPER FOR HOLLOW ROTATING SHAFT

(75) Inventor: Kunihisa TAKKO, Tottori (JP)

(73) Assignee: NOK CORPORATION, Tokyo (JP)

(21) Appl. No.: 12/984,094

(22) Filed: Jan. 4, 2011

(30) Foreign Application Priority Data
Apr. 9, 2010 (JP) 2010-090349

(51) Int. Cl. F16F 7/10

(52) U.S. Cl. 188/379

(57) ABSTRACT

In order to secure an excellent dynamic vibration absorbing characteristic without sacrificing fixing force and improve an assembling property, a dynamic damper for a hollow rotating shaft is provided with a tube body fixed to an inner periphery of the hollow rotating shaft, a pair of end plates fixed to an inner periphery of the tube body so as to be away from each other in an axial direction, a mass body positioned between the end plates and floatingly inserted to the inner periphery of the tube body, and elastic bodies coupling the end plates and the mass body in the axial direction to each other and made of a rubber-like elastic material, whereby the elastic bodies come to shear springs with respect to a vibration in the axially orthogonal direction.

### BACKGROUND OF THE INVENTION

1. Field of the Invention

The present invention relates to a dynamic damper which is attached to an inner peripheral space of a hollow rotating shaft, for example, a propeller shaft of a motor vehicle or the like, and suppresses a vibration and a noise which are generated in the hollow rotating shaft.

2. Description of the Conventional Art

A typical prior art of a dynamic damper, which is attached to an inner peripheral space of a propeller shaft corresponding to a hollow rotating shaft transmitting driving force output from an engine of a motor vehicle via a transmission to rear wheels, and suppressing a vibration and a noise generated in this propeller shaft, is disclosed in Japanese Unexamined Patent Publication No. 9-53686.

A dynamic damper disclosed in the Japanese Unexamined Patent Publication No. 9-53686 is structured, as shown in FIG. 8, such that an elastic body 103 made of a rubber or a synthetic resin material having a rubber-like elasticity is interposed between an outer ring 101 which is pressure inserted to an inner periphery of a propeller shaft 100 and a metal mass body 102 which is arranged in an inner periphery thereof, and the mass body 102 is elastically coupled to the outer ring 101 by a plurality of elastic support portions 103a which are formed in the elastic body 103 at even intervals in a circumferential direction.

Further, a dynamic damper disclosed in Japanese Unexamined Patent Publication No. 2007-177830 is structured, as shown in FIG. 9, such that a tubular elastic bodies 201 are integrally formed over both sides in an axial direction of a metal mass body 202 which is floatingly inserted to an inner periphery of a propeller shaft 200, the tubular elastic body 201 being made of a rubber material or a synthetic resin material having a rubber-like elasticity, and being brought into pressure contact with an inner peripheral surface of the propeller shaft 200.

Further, a dynamic damper disclosed in Japanese Unexamined Patent Publication No. 5-149386 is structured, as shown in FIG. 10, such that a tubular elastic body 301 is integrally formed over both sides in an axial direction of a metal mass body 302 which is floatingly inserted to an inner periphery of a propeller shaft 300, the tubular elastic body 301 being made of a rubber material or a synthetic resin material having a rubber-like elasticity and being brought into pressure contact with an inner peripheral surface of the propeller shaft 300 on the basis of a pressure insertion of fitting brackets 303.

### SUMMARY OF THE INVENTION

### Problem to be Solved by the Invention

However, in the dynamic damper in FIG. 8 (Japanese Unexamined Patent Publication No. 9-53686) , since the elastic support portions 103a of the elastic body 103 elastically supporting the mass body 102 to the outer ring 101 come to compression springs with respect to an input vibration in an axially orthogonal direction, it is necessary to make volumes of the elastic support portions 103a small in order to lower a spring constant of the elastic support portions 103a (further a resonance frequency of an additional vibration system constructed by the mass body 102 and the elastic support portions 103a) for securing a dynamic vibration absorbing characteristic in a low frequency region. Accordingly, there is fear that the elastic support portions 103a become low in their durability and tend to be ruptured.

On the contrary, in the dynamic damper in FIG. 9 (the Japanese Unexamined Patent Publication No. 2007-177830), since the elastic body 201 comes to a shear spring with respect to an input vibration in an axially orthogonal direction, it is possible to secure a dynamic vibration absorbing characteristic in a low frequency region, however, it is necessary to restrict a fastening margin of the elastic body 201 with respect to the inner peripheral surface of the propeller shaft 200 to some extent for this purpose, so that it is hard to secure sufficient fixing force with respect to the propeller shaft 200. Further, in order to prevent a cleaning fluid entered into an inner portion of the propeller shaft 200 from staying without being discharged, in the case of cleaning the propeller shaft 200 after installation to an inner periphery of the propeller shaft 200 and storing in an upright state, a plurality of notches 201a are formed in an outer peripheral surface of the elastic body 201. However, the notches 201a tend to be collapsed by the fastening margin of the elastic body 201, and there is a problem that fixing force to the propeller shaft 200 is lowered, if the notches 201a are enlarged for making the cleaning fluid be easily discharged.

Further, in the dynamic damper in FIG. 10 (the Japanese Unexamined Patent Publication No. 5-149386), since the elastic body 301 comes to the shear spring with respect to the vibration in the axially orthogonal direction, it is possible to secure the dynamic vibration absorbing characteristic in the low frequency region. However, it is necessary to pressure insert the fixing brackets 303 for securing the fixing force with respect to the propeller shaft 300, so that there is a problem in an assembling characteristic into the propeller shaft 300.

The present invention is made by taking the points mentioned above into consideration, and a technical object of the present invention is to secure an excellent dynamic vibration absorbing characteristic without making a sacrifice of the fixing force in a dynamic damper for a hollow rotating shaft, and to improve an assembling property in addition.

### Means for Solving the Problem

As a means for effectively solving the technical object mentioned above, in accordance with a first aspect of the present invention, there is provided a dynamic damper for a hollow rotating shaft, comprising:

a tube body fixed to an inner periphery of the hollow rotating shaft, of which a vibration is to be reduced;

a pair of end plates fixed to an inner periphery of the tube body so as to be away from each other in an axial direction;

a mass body positioned between the end plates and floatingly inserted to the inner periphery of the tube body; and

elastic bodies coupling each of the end plates and the mass body in the axial direction to each other and made of a rubber-like elastic material.

Further, in accordance with a second aspect of the present invention, there is provided a dynamic damper for a hollow rotating shaft as recited in the first aspect, wherein inner peripheral elastic layers made of a rubber-like elastic material are formed at a plurality of positions in a circumferential direction in the inner peripheral surface of the tube body, and fitting surfaces and non-fitting surfaces are alternately formed in outer peripheral surfaces of the endplates, the fitting surface being capable of coming into close contact with an inner peripheral surface of each of the inner peripheral elastic layers as well as being capable of being floatingly inserted to the inner peripheral surface of the tube body, and the non-fitting surface being not brought into pressure contact with the inner peripheral elastic layer.

Further, in accordance with a third aspect of the present invention, there is provided a dynamic damper for a hollow rotating shaft as recited in the first aspect, wherein the end plates are pressure inserted to the inner peripheral surface of the tube body.

Further, in accordance with a fourth aspect of the present invention, there is provided a dynamic damper for a hollow rotating shaft as recited in the first aspect, wherein outer peripheral elastic layers made of a rubber-like elastic material and brought into pressure contact with the inner peripheral surface of the hollow rotating shaft are formed in an outer peripheral surface of the tube body.

### Effect of the Invention

On the basis of the dynamic damper for the hollow rotating shaft in accordance with the first aspect, since the elastic bodies come to shear springs with respect to the vibration in the axially orthogonal direction, and the elastic bodies do not support the mass body by being pressure inserted to the inner peripheral surface of the tube body, but are fixed to the tube body via the end plates, it is possible to secure an excellent dynamic vibration absorbing characteristic in a wide vibration frequency range.

On the basis of the dynamic damper for the hollow rotating shaft in accordance with the second aspect, since the fitting surfaces are brought into close contact with the inner peripheral surface of each of the inner peripheral elastic layers so as to be supported, by appropriately rotating the end plates after floatingly inserting the end plates coupled to the mass body via the elastic bodies, to the inner periphery of the tube body in such a manner that the fitting surfaces are positioned at the inner peripheral side of the portions between the inner peripheral elastic layers in the inner peripheral surface of the tube body, it is possible to easily assemble. Further, since gaps are formed between the inner peripheral surface of the tube body and the non-fitting surfaces of the end plate, it is possible to easily discharge a liquid or the like through the gaps, even if the liquid makes an intrusion into the inner peripheral space of the tube body.

On the basis of the dynamic damper for the hollow rotating shaft in accordance with the third aspect, it is possible to easily assemble only by pressure inserting the end plates coupled to the mass body via the elastic bodies to the inner peripheral surface of the tube body.

On the basis of the dynamic damper for the hollow rotating shaft in accordance with the fourth aspect, it is possible to easily and firmly attach the dynamic damper to the inner peripheral surface of the hollow rotating shaft, by the outer peripheral elastic layers formed in the outer peripheral surface of the tube body.

### BRIEF EXPLANATION OF DRAWINGS

FIG. 1 is a sectional perspective view showing a first embodiment of a dynamic damper for a hollow rotating shaft in accordance with the present invention by cutting along a plane passing through an axis;

FIG. 2 is a perspective view showing an integrally formed product of a tube body, an inner peripheral elastic layers and an outer peripheral elastic layers in the dynamic damper for the hollow rotating shaft in FIG. 1;

FIG. 3 is a perspective view showing an integrally formed product of end plates, a mass body and elastic bodies in the dynamic damper for the hollow rotating shaft in FIG. 1;

FIG. 4 is a perspective view showing a process of assembling the integrally formed product of the end plates, the mass body and the elastic bodies in the tube body, in the dynamic damper for the hollow rotating shaft in FIG. 1;

FIG. 5 is a perspective view showing a finish state of the assembly of the integrally formed product of the end plates, the mass body and the elastic bodies, and the tube body, in the dynamic damper for the hollow rotating shaft in FIG. 1;

FIG. 6 is a sectional perspective view showing a second embodiment of the dynamic damper for the hollow rotating shaft in accordance with the present invention;

FIG. 7 is a perspective view showing an integrally formed product of end plates, a mass body and elastic bodies in the dynamic damper for the hollow rotating shaft in FIG. 6;

FIG. 8 is a sectional perspective view showing an example of a conventional dynamic damper for a hollow rotating shaft, by cutting along a plane passing through an axis;

FIG. 9 is a sectional perspective view showing another example of the conventional dynamic damper for the hollow rotating shaft, by cutting along a plane passing through an axis; and

FIG. 10 is a sectional perspective view showing another example of the conventional dynamic damper for the hollow rotating shaft, by cutting along a plane passing through an axis.

### DETAILED DESCRIPTION OF PREFERRED EMBODIMENT

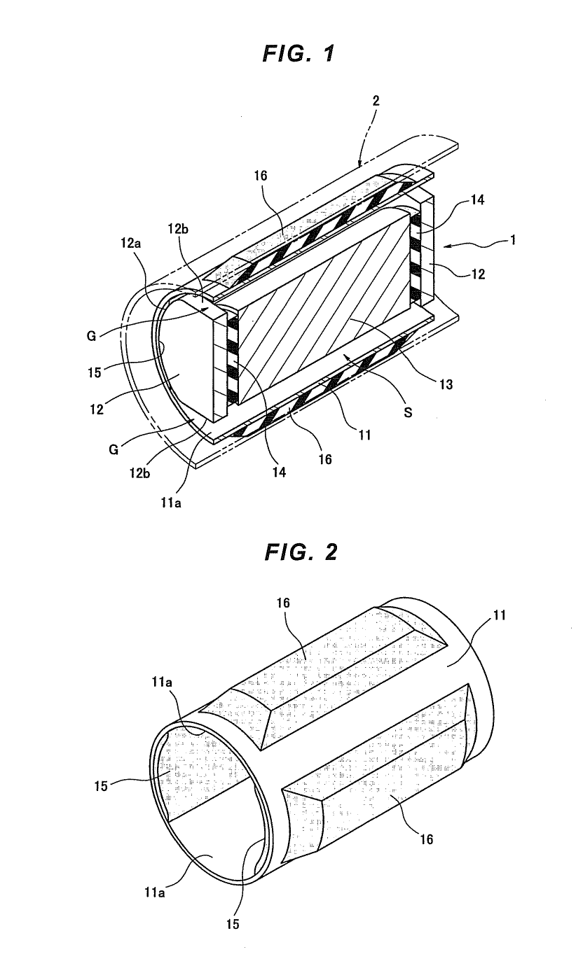

A description will be given below of preferable embodiments of a dynamic damper for a hollow rotating shaft in accordance with the present invention with reference to the accompanying drawings. First of all, FIGS. 1 to 5 show a first embodiment.

In FIG. 1, reference numeral 1 denotes a dynamic damper, and reference numeral 2 denotes a propeller shaft of a motor vehicle. The propeller shaft 2 corresponds to the hollow rotating shaft described in the first aspect, in other words, it is formed in a hollow cylindrical shape, and the dynamic damper 1 is attached to an inner peripheral space of the propeller shaft 2.

The dynamic damper 1 is provided with a tube body 11 which is fixed to an inner periphery of the propeller shaft 2 of which a vibration is to be reduced, a pair of end plates 12 and 12 which are fixed to an inner periphery of the tube body 11 so as to be away from each other in an axial direction, a mass body 13 which is positioned between the end plates 12 and 12 and is floatingly inserted to the inner periphery of the tube body 11, and elastic bodies 14 and 14 which couple the end plates 12 and the mass body 13 to each other in an axial direction and are made of a rubber-like elastic material (a rubber material or a synthetic resin material having a rubber-like elasticity).

The tube body 11 is, for example, made of a metal, and is structured, as shown in FIG. 2, such that a pair of inner peripheral elastic layers 15 and 15 made of a rubber-like elastic material are integrally formed at symmetrical positions which are 180 degree apart in an inner peripheral surface, and a plurality of outer peripheral elastic layers 16, 16, . . . , which are made of a rubber-like elastic material and can be brought into pressure contact with an inner peripheral surface of the propeller shaft 2 shown in FIG. 1, are integrally formed in an outer peripheral surface at even internals in a circumferential direction.

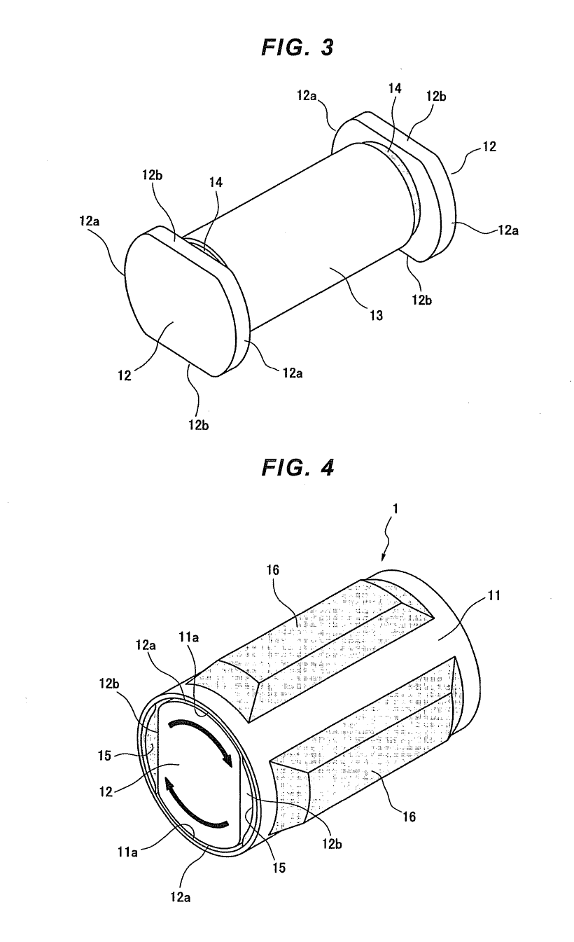

The end plate 12 is, for example, made of a metal, and is formed in such a shape that 180 degree apart symmetrical positions of a disc is cut in parallel to each other, as shown in FIG. 3. Accordingly, in an outer peripheral surface thereof, there are alternately formed a pair of circular arc face shaped fitting surfaces 12a and 12a, which can be brought into pressure contact with the inner peripheral elastic layers 15 and 15 provided in the inner peripheral surface of the tube body 11, and can be floatingly inserted to the inner periphery of the tube body 11 at positions between the inner peripheral elastic layers 15 and 15, and a pair of planar non-fitting surfaces 12b and 12b which can not be brought into pressure contact with the inner peripheral elastic layers 15 and 15.

The mass body 13 is manufactured, for example, by cutting a metal rod, that is, is formed in a columnar shape, and an outer diameter thereof is smaller than an inner diameter of the tube body 11.

The elastic bodies 14 are integrally vulcanization bonded to portions between both the end surfaces in the axial direction of the mass body 13, and the end plates 12 and 12 opposed thereto, and are structured such as to be exposed to repeated shear deformations mainly in accordance with relative displacements in an axially orthogonal direction of the propeller shaft 2 and the mass body 13 on the basis of input of a vibration.

A resonance frequency of an additional vibration system constructed by the mass body 13 and the elastic bodies 14 and 14 at the both sides thereof, is synchronized to a frequency band in which an amplitude of the vibration generated in the propeller shaft 2 is increased most, on the basis of a mass of the mass body 13 and a spring constant of the elastic bodies 14.

The dynamic damper 1 in accordance with the first embodiment of the present invention constructed as mentioned above is assembled by incorporating an integrally formed product of the end plates 12 and 12, the mass body 13 and the elastic bodies 14 and 14 as shown in FIG. 3, in an integrally formed product of the tube body 11, the inner peripheral elastic layers 15 and the outer peripheral elastic layers 16 as shown in FIG. 2.

In more detail, the integrally formed product of the endplates 12 and 12, the mass body 13 and the elastic bodies 14 and 14 is floatingly inserted to the inner periphery of the tube body 11 as shown in FIG. 4, while setting first of all such that a pair of circular arc face shaped fitting surfaces 12a and 12a in the end plates 12 are positioned at the inner periphery of the portions 11a and 11a in which the inner peripheral elastic layers 15 are not formed in the inner peripheral surface of the tube body 11 shown in FIG. 2.

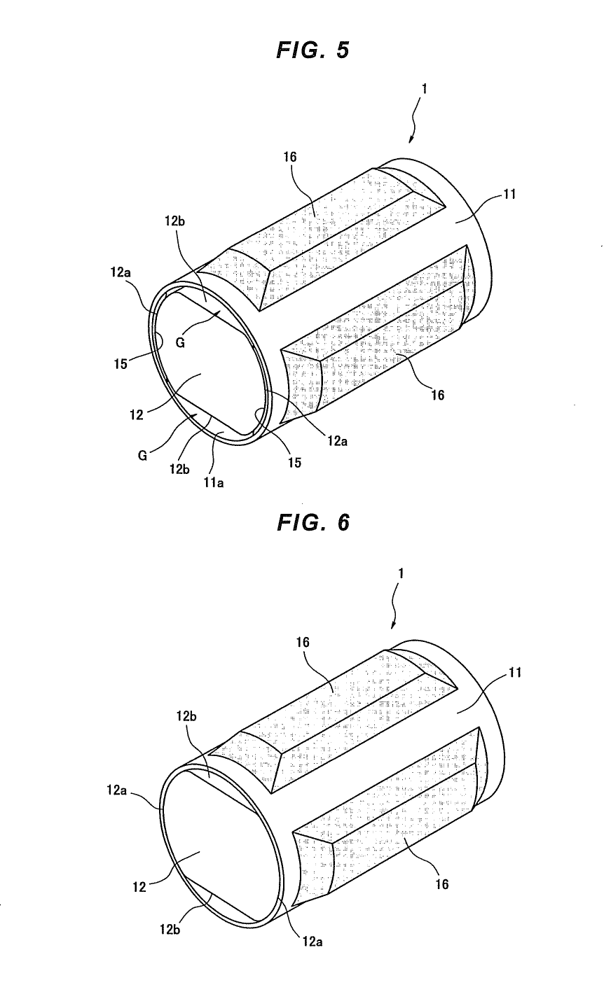

Next, the planar non-fitting surfaces 12b and 12b in the end plates 12 are gripped by a suitable jig, and each of the end plates 12 is rotated appropriately (at about 90 degree in the illustrated embodiment) in a circumferential direction with respect to the tube body 11, as shown by thick arrows in FIG. 4. Accordingly, as shown in FIG. 5, the circular arc face shaped fitting surfaces 12a and 12a in the end plates 12 come to a state of being brought into close contact with and fitting to inner peripheral surfaces of the inner peripheral elastic layers 15 and 15 while compressing each of them in the inner periphery of the tube body in a diametrical direction, and an assembly is finished. Therefore, it is possible to easily assemble.

In this case, the inner peripheral elastic layers 15 and 15 in the inner periphery of the tube body 11 and the circular arc face shaped fitting surfaces 12a and 12a in the end plates 12 may be bonded to each other without a large fastening margin being given therebetween.

The dynamic damper 1 assembled as mentioned above is attached by pressure inserting the tube body 11 to a predetermined position in the inner peripheral surface of the propeller shaft 2 via the outer peripheral elastic layers 16 which are integrally provided in an outer peripheral surface thereof, as shown in FIG. 1.

In the case that the propeller shaft 2 is cleaned after the dynamic damper 1 is attached to the inner periphery of the propeller shaft 2, a cleaning fluid entered into the inner portion of the dynamic damper (an inner peripheral space S of the tube body 11) in the cleaning process is easily discharged through arcuate gaps G which are formed between the inner peripheral surfaces 11a of the tube body 11 and the non-fitting surfaces 12b and 12b of the end plate 12. Accordingly, it is possible to prevent the cleaning fluid from staying in the inner peripheral space S of the tube body 11. Further, since the liquid discharge is not achieved by the notches which are formed in a pressure inserting portion of an elastic body in a structure of the conventional one, the liquid discharging function is not deteriorated by a fastening margin.

Further, since the outer peripheral elastic layers 16 brought into pressure contact with the inner peripheral surface of the propeller shaft 2 are formed so as to be divided into a plurality of sections in the circumferential direction, the cleaning fluid flowed into the inner peripheral space of the propeller shaft 2 is also discharged from gutter shaped gaps formed between the outer peripheral elastic layers 16, 16, . . . between the inner peripheral surface of the propeller shaft 2 and the outer peripheral surface of the tube body 11.

Next, when the propeller shaft 2 is rotated in the installed state shown in FIG. 1, the vibration due to the rotation is generated in the axially orthogonal direction. Then, since the resonance frequency of the additional vibration system constructed by the mass body 13 and the elastic bodies 14 and 14 at both sides thereof is synchronized to the frequency band in which the amplitude of the vibration of the propeller shaft 2 is increased most, the additional vibration system resonates in the frequency band mentioned above, and a phase of a vibration wave form thereof is a reverse phase to that of the input vibration. Therefore, it is possible to reduce a peak of the amplitude of the input vibration on the basis of a dynamic vibration absorbing action, and it is possible to effectively reduce the vibration and a noise of the propeller shaft 2.

Further, in accordance with the dynamic damper 1, since the elastic bodies 14 come to shear springs with respect to the vibration in the axially orthogonal direction, and the elastic bodies 14 do not support the mass body 13 by being pressure inserted to the inner periphery of the tube body 11, but are fixed to the tube body 11 via the endplates 12, a resonance frequency characteristic by the elastic bodies 14 is not affected by the compression or the like, and it is possible to secure an excellent dynamic vibration absorbing characteristic in a wide vibration frequency range.

Further, since the integrally formed product of the endplates 12 and 12, the mass body 13 and the elastic bodies 14 and 14 is formed as a separate member with respect to the fixed portion (the integrally formed product of the tube body 11, the inner peripheral elastic layers 15 and the outer peripheral elastic layers 16) to the propeller shaft 2, it is possible to cope with the case that the diameter of the propeller shaft 2 is changed, for example, by changing a thickness in a diametrical direction of the outer peripheral elastic layers 16 or the tube body 11, and it is possible to use the integrally formed product of the end plates 12 and 12, the mass body 13 and the elastic bodies 14 and 14 in common. Accordingly, it is possible to reduce a cost necessary for a design change.

Further, since the integrally formed product of the tube body 11, the inner peripheral elastic layers 15 and the outer peripheral elastic layers 16, and the integrally formed product of the end plates 12 and 12, the mass body 13 and the elastic bodies 14 and 14 are the separate members from each other, the inner peripheral elastic layers 15 and the outer peripheral elastic layers 16 can be made of a different rubber-like elastic material from that of the elastic body 14.

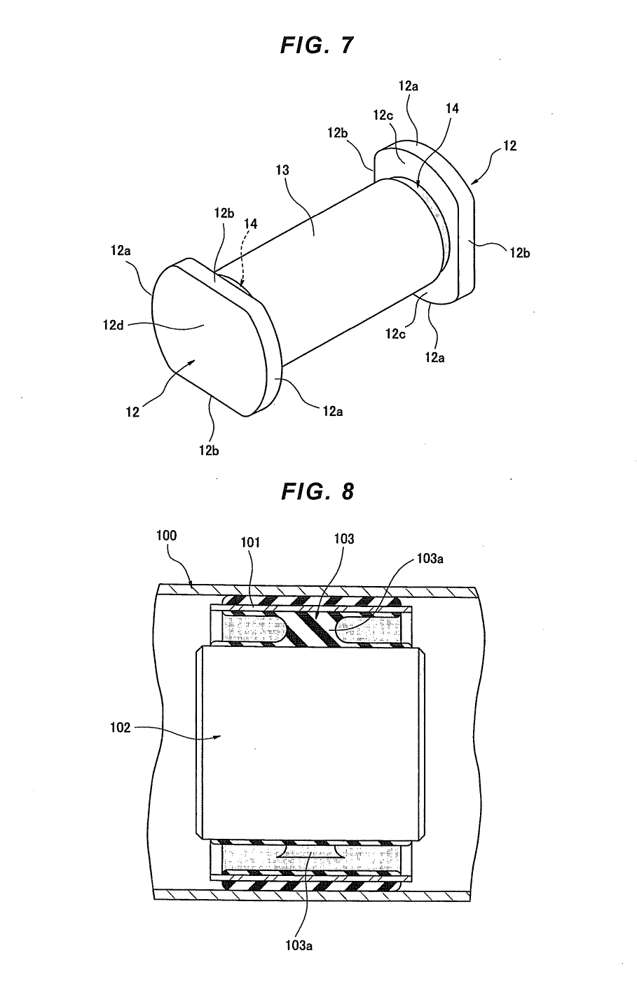

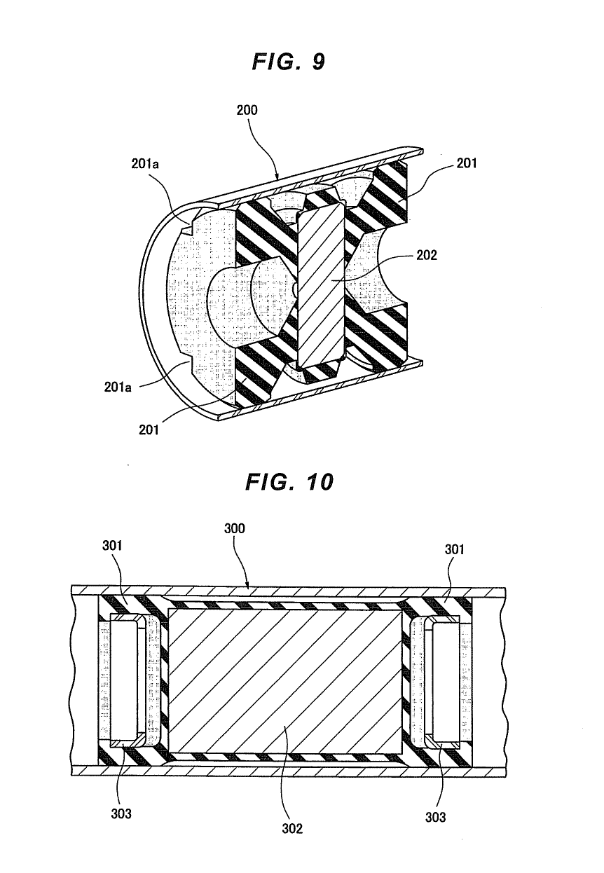

FIGS. 6 and 7 show a second embodiment of the dynamic damper for the hollow rotating shaft in accordance with the present invention. In the dynamic damper 1 in accordance with this embodiment, a difference from the first embodiment mentioned above exists in a point that the inner peripheral elastic layer is not formed in the inner peripheral surface of the tube body 11, and the circular arc face shaped fitting surfaces 12a and 12a in the end plates 12 are pressure inserted to the inner peripheral surface of the tube body 11. The other portions are basically the same as those of the first embodiment.

In other words, in accordance with the second embodiment, the circular arc face shaped fitting surfaces 12a and 12a in the endplates 12 have a suitable fastening margin with respect to the inner peripheral surface of the tube body 11, and the integrally formed product of the end plates 12 and 12, the mass body 13 and the elastic bodies 14 and 14 is preferably structured such that the end plates 12 and 12 at both sides in the axial direction of the mass body 13 are arranged in such a manner that the fitting surfaces 12a and 12a have different phases from each other (90 degree different phases in the illustrated embodiment), as shown in FIG. 7.

In accordance with the structure mentioned above, since it is possible to simultaneously press an outer surface 12d in the one end plate 12 and inner surfaces 12c and 12c of the other end plate 12 by inserting a jig (not shown) which can come into contact with the inner surfaces 12c and 12c close to the fitting surfaces 12a and 12a in the other end plate 12 from outer peripheries of the non-fitting surfaces 12b and 12b in the one end plate 12, it is possible to pressure insert the end plates 12 and 12 to the inner peripheral surface of the tube body 11 without the elastic bodies 14 and 14 being compressed between the mass body 13 and the end plates 12 and 12. Further, in this case, it is not necessary to rotate the end plates 12 and in the circumferential direction thereof with respect to the tube body 11 after the pressure insertion.

In addition, in each of the embodiments mentioned above, the outer peripheral elastic layers 16 are formed in a shape of being separated into a plurality of sections in the circumferential direction, taking into consideration a discharging characteristic of the cleaning fluid. However, they may be formed in a cylindrical surface shape of being continuous in the circumferential direction.

The entire disclosure of Japanese Patent Application No. 2010-090349, filed Apr. 9, 2010, is expressly incorporated by reference herein.

What is claimed is:

1. A dynamic damper for a hollow rotating shaft, comprising:
a tube body fixed to an inner periphery of the hollow rotating shaft, of which a vibration is to be reduced;
a pair of end plates fixed to an inner periphery of the tube body so as to be away from each other in an axial direction;
a mass body positioned between the end plates and floatingly inserted to the inner periphery of said tube body; and
elastic bodies coupling each of said end plates and the mass body in the axial direction to each other and made of a rubber-like elastic material.

2. The dynamic damper for a hollow rotating shaft as claimed in claim 1, wherein inner peripheral elastic layers made of a rubber-like elastic material are formed at a plurality of positions in a circumferential direction in the inner peripheral surface of the tube body, and fitting surfaces and non-fitting surfaces are alternately formed in outer peripheral surfaces of the end plates, the fitting surface being capable of coming into close contact with an inner peripheral surface of each of said inner peripheral elastic layers as well as being capable of being floatingly inserted to the inner peripheral surface of the tube body, and the non-fitting surface being not brought into pressure contact with said inner peripheral elastic layer.

3. The dynamic damper for a hollow rotating shaft as claimed in claim 1, wherein the end plates are pressure inserted to the inner peripheral surface of the tube body.

4. The dynamic damper for a hollow rotating shaft as claimed in claim 1, wherein outer peripheral elastic layers made of a rubber-like elastic material and brought into pressure contact with the inner peripheral surface of the hollow rotating shaft are formed in an outer peripheral surface of the tube body.
